(19) United States
(12) Patent Application Publication
(10) Pub. No.: US 2008/0181215 A1
(43) Pub. Date: Jul. 31, 2008

(54) System for remotely distinguishing an operating system

(76) Inventors: Brooks Bollich, Ft. Collins, CO (US); Michael Grove, Nashua, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/698,333

(22) Filed: Jan. 26, 2007

(51) Int. Cl. H04L 12/56

(52) U.S. Cl. 370/389

(57) ABSTRACT

A method for remotely identifying an operating system comprises sending a first User Datagram Protocol (UDP) packet to a port that is not in use on a target and monitoring a response evoked by the first sent UDP packet. At least one Internet Control Message Protocol (ICMP) packet is sent to the target and the response evoked by the sent ICMP packet(s) monitored. A second UDP packet is sent to the port with an Internet Protocol (IP) timestamp option set in an IP header and a response evoked by the second sent UDP packet is monitored. The operating system is identified at least partially based on the responses to the first and second sent UDP packets.

### BACKGROUND OF THE INVENTION

Devices and systems connected on a network perform various interactions. Some interactions may require identification of the operating system executing in a computer system. Other interactions may make use of such operating system identification. Operating system (OS) identification, which may be called OS fingerprinting, is the process of determining what operating system is running on a device. In some circumstances, identification of the operating system in a corresponding computer can be used to enable or facilitate a particular functionality. For example, identification of the operating system can be used to determine how a requesting device interacts with another device. In other examples, a requesting device may limit interactions to corresponding devices that run a secure operating system so that identification of the operating system is prerequisite to interacting.

### SUMMARY

In accordance with an embodiment of a method for remotely identifying an operating system, a first User Datagram Protocol (UDP) packet is sent to a port that is not in use on a target and a response evoked by the first sent UDP packet is monitored. At least one Internet Control Message Protocol (ICMP) packet is sent to the target and the response evoked by the sent ICMP packet(s) monitored. A second UDP packet is sent to the port with an Internet Protocol (IP) timestamp option set in an IP header and a response evoked by the second sent UDP packet is monitored. The operating system is identified at least partially based on the responses to the first and second sent UDP packets.

### BRIEF DESCRIPTION OF THE DRAWINGS

Embodiments of the invention relating to both structure and method of operation may best be understood by referring to the following description and accompanying drawings:

FIG. 1 shows a combined schematic block diagram and an Internet Protocol (IP) functional diagram illustrating an embodiment network system that is adapted to detect and identify an operating system running a target device communicating on a network;

FIGS. 2A, 2B, 2C, 2D, 2E, and 2F are flow charts showing embodiments of methods for remotely identifying an operating system;

FIG. 3 is a flow chart that depicts another embodiment of a method for operating system discovery and identification, specifically a method for remotely differentiating HP-UX from Solaris 10; and

FIG. 4 is an output printout showing results of a test run an embodiment of a method for operating system discovery and identification using IP options specifying a record route option.

### DETAILED DESCRIPTION

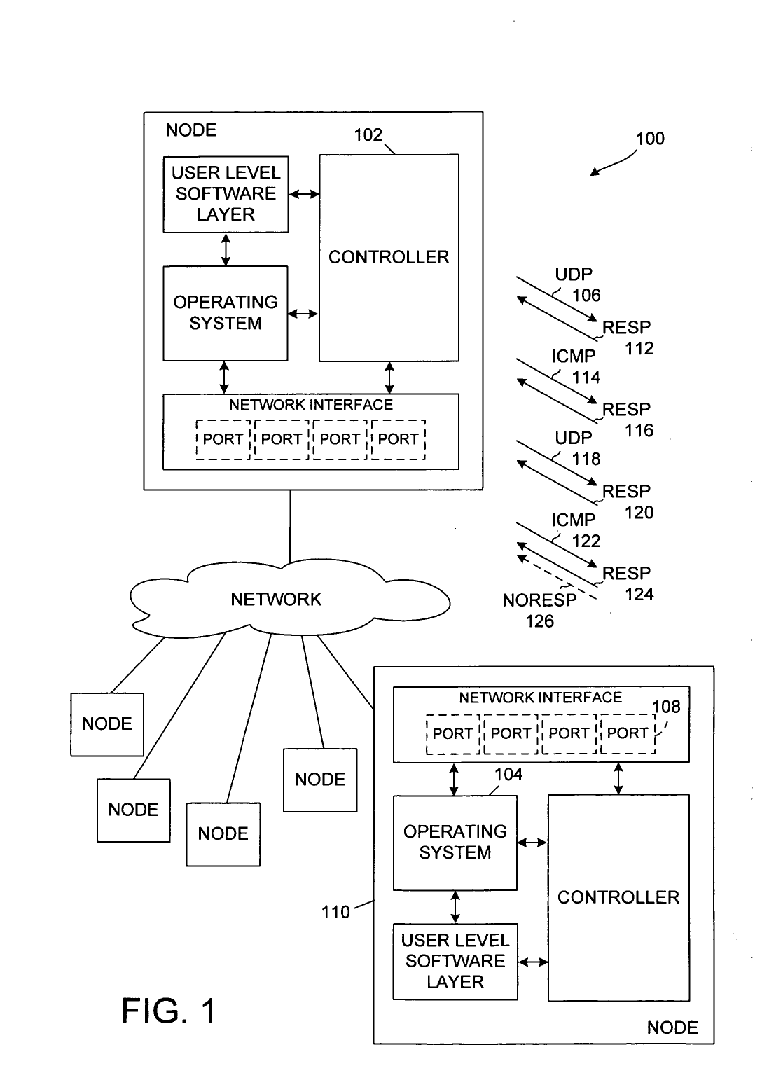

Referring to FIG. 1 a combined schematic block diagram and Internet Protocol (IP) functional diagram illustrate an embodiment of a network system 100 that is adapted to detect and identify an operating system running a target device communicating on a network. The network system 100 comprises a controller 102 that remotely identifies an operating system 104 by sending a first User Datagram Protocol (UDP) packet 106 to a port 108 that is not in use on a target 110 and monitoring a response 112 evoked by the UDP packet. The controller 102 also sends one or more Internet Control Message Protocol (ICMP) packets 114 to the target 110 and monitors a response 116 evoked by the sent ICMP packet(s), and sends a second UDP packet 118 to the port 108 with an Internet Protocol (IP) timestamp option set in an IP header and monitors a response 120 evoked by the second UDP packet. The controller 102 identifies the operating system 104 at least partially based on the responses 112,120 to the first and second UDP packets 106, 118.

User Datagram Protocol (UDP) is one of the core protocols of the Internet protocol (IP) suite. Programs on networked computers can use UDP to send short messages called datagrams to one another. UDP is less reliable and does not implement ordering guarantees of TCP so that datagrams may be dropped or arrive out of order. Without the overhead of checking of packet arrival, UDP is faster and more efficient for many lightweight or time-sensitive purposes. UDP also has a stateless nature that is useful for servers that answer small queries from huge numbers of clients so that UDP is generally considered superior to TCP in broadcast and multicast applications.

Internet Control Message Protocol (ICMP) is also one of the core protocols of the IP suite and is primarily used by networked computer operating systems to send error messages, for example indicating when a requested service is not available or a host or router was not accessed. ICMP is not usually used directly by user network applications other than the ping tool which sends and receives respective ICMP Echo Request messages and Echo Response messages to determine whether a host is reachable and round-trip duration of sending messages and receiving the response. ICMP messages are contained within standard IP datagrams but are usually processed as a special case and distinguished from normal IP processing rather than processed as a normal sub-protocol of IP.

In some embodiments, the controller 102 can identify the operating system 104 based on the responses 112,120 to the first and second UDP packets 106,118 in combination with a response or responses 116 to the ICMP packet or packets 114.

In some embodiments or implementations, the controller 102 can operate to identify the operating system 104 by sending one or more Internet Control Message Protocol (ICMP) packets 114 to the target 110 after monitoring the response 112 evoked by the first UDP packet 106 and monitors a response 116 evoked by the sent ICMP packet or packets 114. The controller 102 can identify the operating system 104 based on the responses 112, 120 to the first and second UDP packets 106,118 and the response or responses 116 to the sent ICMP packet or packets 114.

In a particular application, an embodiment of the network system 100 can identify an operating system 104 of a Solaris™ machine, such as a Solaris™ 10 machine. Specifically, the network system 100 can remotely differentiate the HP-UX operating system made available by Hewlett Packard Company and Solaris 10. The controller 102 can send the first User Datagram Protocol (UDP) packet 106 with a payload of a preselected number of bytes and identify the operating system 100 as possibly being Solaris if the response 112 evoked by the first sent UDP packet 106 is an Internet Control Message Protocol (ICMP) destination unreachable reply. The controller 102 can identify the operating system 104 as possibly Solaris if the destination unreachable reply has a preselected size.

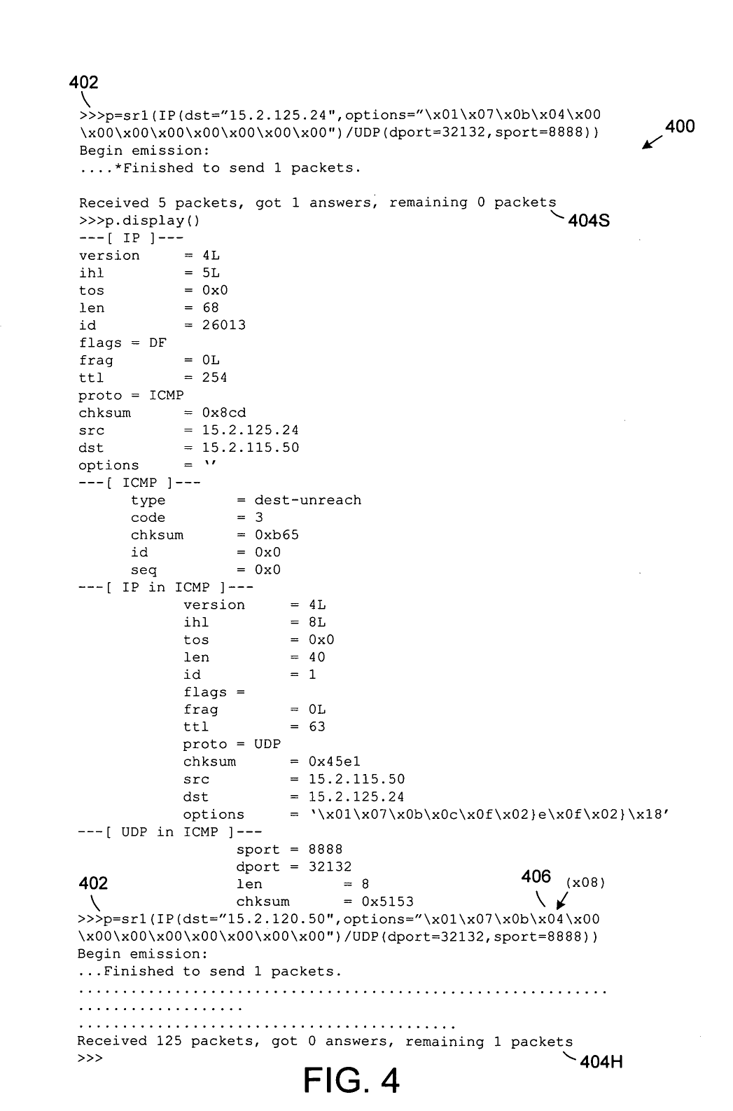

In some embodiments of the application for identification of the Solaris operating system 104, the controller 102 can also send an Internet Control Message Protocol (ICMP) timestamp re FIG. 4, an output printout depicts results of a test run an embodiment of a method for operating system discovery and identification quest 122 to the target 110. The controller 102 identifies the operating system 104 as Solaris if the target 110 responds 124 to the ICMP timestamp request 122 and identifies the operating system 104 as possibly Solaris if the target 110 does not respond 126 to the ICMP timestamp request 122.

In a particular implementation, the controller 102 can send the second UDP packet 118 to the port 108 with the Internet Protocol (IP) timestamp option set in an IP header specifying a timestamp type, a predetermined timestamp length, a predetermined timestamp pointer, and null for other timestamp fields. The controller 102 identifies the operating system 104 as Solaris if the target 110 responds to the second UDP packet 118 with an ICMP destination unreachable reply. In a specific embodiment, the controller 102 can send the second UDP packet 118 to the port 108 with the Internet Protocol (IP) timestamp option set in an IP header specifying a timestamp type of 0×44, a predetermined timestamp length of 0×28, a predetermined timestamp pointer of 0×05, and null for other timestamp fields.

The illustrative network system 100 can be an OpenView Service Discovery Component that employs an ICMP-based operating system discovery technique that exploits the unique characteristics of UDP and ICMP datagrams to determine the operating system type of a remote target machine. The technique enables the characteristics to be exploited to differentiate HP-UX operating systems from Solaris 10 operating systems.

The OpenView Service Discovery Component can use an open source tool called xprobe version 0.0.1 to identify the operating system executing on a remote target system. The xprobe version 0.0.1 tool includes a known algorithm for differentiating operating system types which is insufficient when attempting to determine the operating system of a Solaris 10 machine. Xprobe version 0.0.1 erroneously identifies Solaris 10 machines as HP-UX. The illustrative network system 100 avoids drawbacks of the xprobe version 0.0.1 tool and enables correct identification of the Solaris 10 machines.

The depicted network system 100 enables differentiation of versions of HP-UX, including versions newer than HP-UX 11.0, from Solaris 10 by exploiting an Internet Protocol (IP) timestamp feature of the IP protocol.

The timestamp field defined according to Transmission Control Protocol (TCP)/Internet Protocol (IP) specifications of RFC (Request for Comment) 791, Internet Protocol, Darpa Internet Program Protocol Specification (September 1981), can be used to differentiate HP-UX from Solaris 10. Specifically, when the timestamp field option is specified with a UDP packet to a down port to a device executing HP-UX such as HP-UX 11.x, the HP-UX system drops the packet. In contrast, the Solaris 10 system responds with a destination unreachable reply while also updating the IP options section with the timestamp.

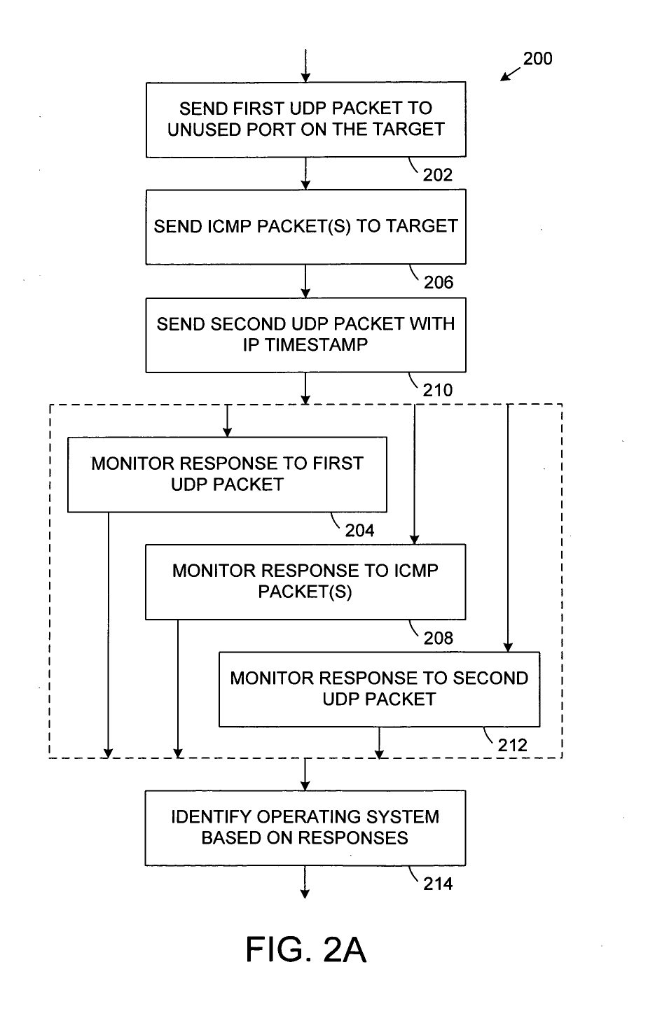

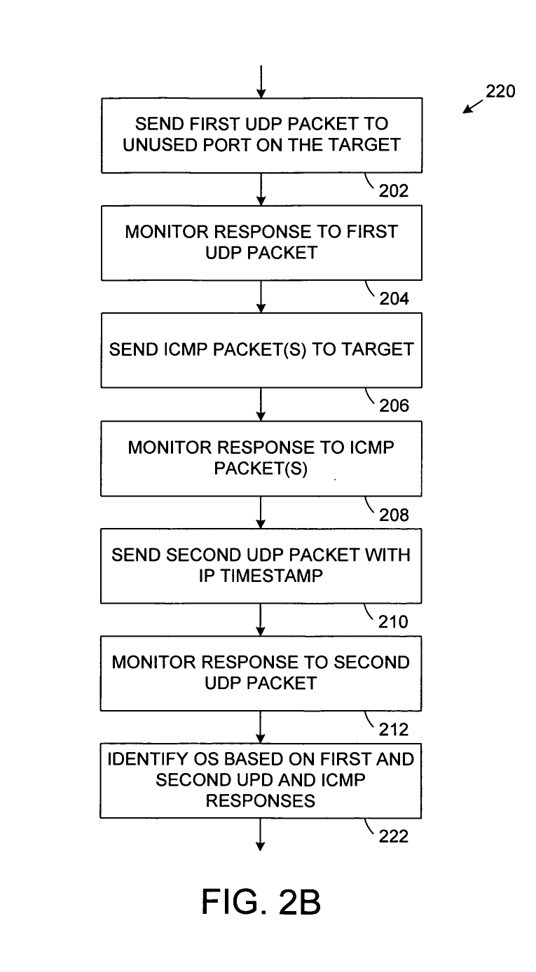

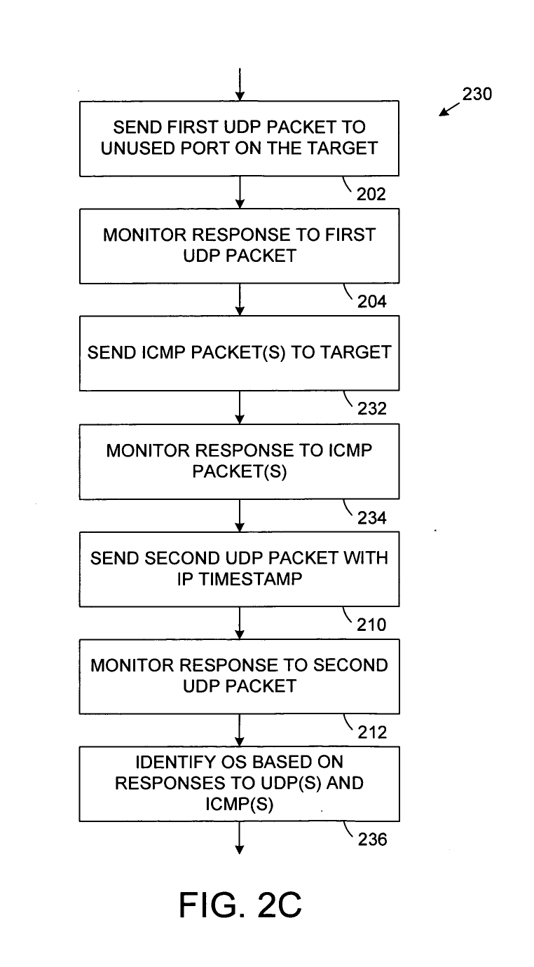

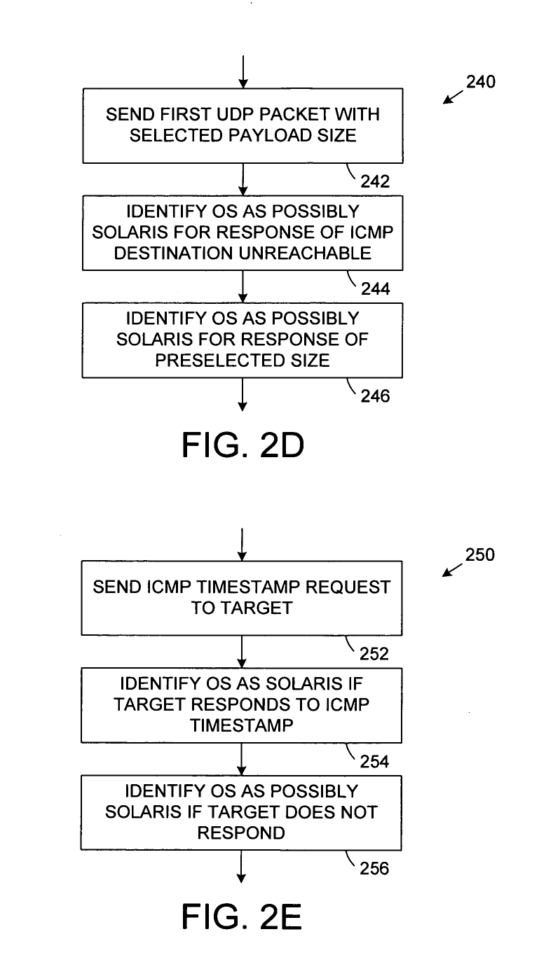

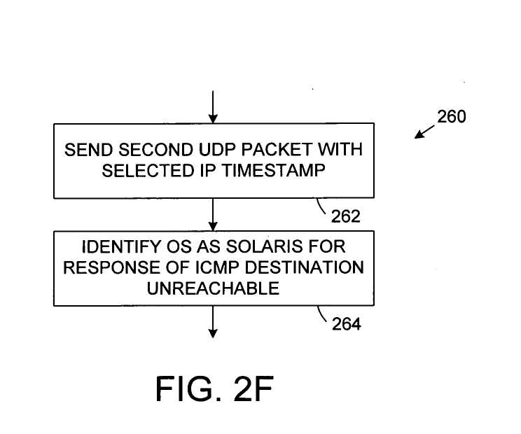

Referring to FIGS. 2A, 2B, 2C, 2D, 2E, and 2F, several flow charts illustrate embodiments of methods for remotely identifying an operating system. As shown in FIG. 2A, an operating system discovery method 200 comprises sending 202 a first User Datagram Protocol (UDP) packet to a port that is not in use on a target and monitoring 204 a response evoked by the first sent UDP packet. At least one Internet Control Message Protocol (ICMP) packet is sent 206 to the target and the response evoked by the sent ICMP packet or packets is monitored 208. A second UDP packet is sent 210 to the port with an Internet Protocol (IP) timestamp option set in an IP header and the response evoked by the second sent UDP packet is monitored 212. The operating system is identified 214 at least partially based on the responses to the first and second sent UDP packets.

Referring to FIG. 2B, in another embodiment of an operating system identification method 220 the operating system can be identified 222 based on the responses to the first and second sent UDP packets and the response or responses to the sent ICMP packet or packets.

FIG. 2C depicts an embodiment of an operating system identification method 230 in which one or more Internet Control Message Protocol (ICMP) packets are sent 232 to the target subsequent to monitoring 204 the response evoked by the first sent UDP packet, then the response evoked by the ICMP packet or packets is monitored 234. The operating system can be identified 236 based on the responses to the first and second sent UDP packets and the response or responses to the sent ICMP packet or packets.

FIG. 2D depicts an embodiment of a particular application of an operating system identification method 240. The first User Datagram Protocol (UDP) packet can be sent 242 with a payload of a preselected number of bytes. The operating system can be identified 244 as possibly Solaris if the response evoked by the first sent UDP packet is an Internet Control Message Protocol (ICMP) destination unreachable reply. The operating system can further be identified 246 as possibly Solaris if the destination unreachable reply has a preselected size.

FIG. 2E shows another embodiment of a Solaris operating system identification method 250. An Internet Control Message Protocol (ICMP) timestamp request can be sent 252 to the target. The operating system can be identified 254 as Solaris if the target responds to the ICMP timestamp request. The operating system can be identified 256 as possibly Solaris if the target does not respond to the ICMP timestamp request.

FIG. 2F illustrates a further embodiment of a Solaris operating system identification method 260. The second UDP packet can be sent 262 to the port with the Internet Protocol (IP) timestamp option set in an IP header specifying a timestamp type, a predetermined timestamp length, a predetermined timestamp pointer, and null for other timestamp fields. The operating system can be identified 264 as Solaris if the target responds to the second UDP packet with an ICMP destination unreachable reply. In a particular embodiment, the second UDP packet can be sent to the port with the Internet Protocol (IP) timestamp option set in an IP header specifying a timestamp type of 0×44, a predetermined timestamp length of 0×28, a predetermined timestamp pointer of 0×05, and null for other timestamp fields.

The illustrative method enables efficient differentiation of HP-UX and Solaris operating systems using ICMP fingerprinting.

In some embodiments, the illustrative operating system (OS) type discovery techniques can be extended from xprobe version 0.0.1 and include multiple enhancements and extensions. The depicted OS type discovery scheme performs ICMP fingerprinting by sending messages to a target device which evokes ICMP responses. The ICMP responses vary for different operating systems and can be used to identify the remote operating system. Conventional ICMP fingerprinting has limitations, for example operating systems can be configured to behave differently in handling ICMP messages, possibly producing incorrect data.

Other embodiments of an OS type discovery technique can be extended from nmap, a security scanner that is used to evaluate computer security and discover services or servers on a network.

In various embodiments, the OS type discovery method can exploit capabilities of an application programming interface (API) such as pcap or related implementations of libpcap, WinPcap, or the like for packet capturing. For example, pcap enables several options for OS type discovery that can be used by nmap and Xprobe.

The illustrative OS type discovery techniques can distinguish Solaris 10 machines from HP-UX 11.x and extend capabilities over either Xprobe or Nmap that do not include an ICMP-based solution for distinguishing the platforms.

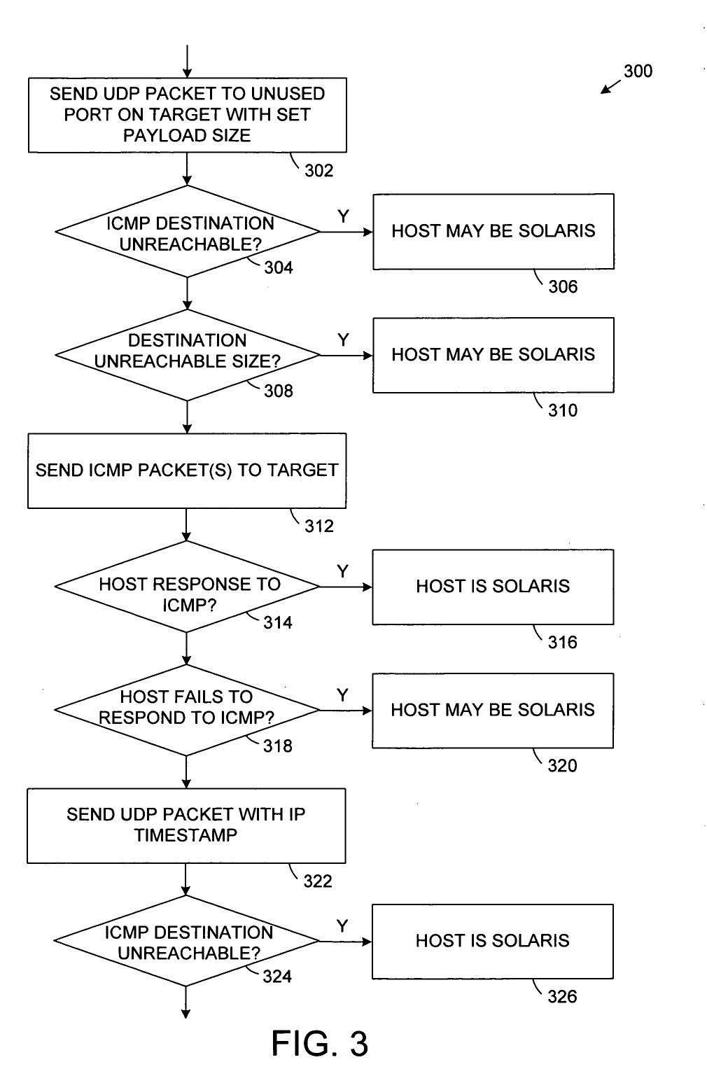

Referring to FIG. 3, a flow chart depicts another embodiment of a method for operating system discovery and identification, specifically a method for remotely differentiating HP-UX from Solaris 10. In the example, a method for remotely determining the operating system of a Solaris 10 machine is disclosed.

An example of a method of OS type identification can be based on an algorithm introduced in the open source tool Xprobe, version 0.0.1, that relies on analysis of ICMP packets and IP headers. Xprobe version 0.0.1 OS type identification incorrectly identifies Solaris 10 machines as HP-UX machines. An enhancement to the algorithm enables identification of Solaris 10 and possibly additional versions of Solaris. The illustrative enhancement is configured to operate in conditions that a target host is less than 24 round trip hops from the machine that is used to remotely determine the operating system for the target.

In the illustrative method 300, Solaris can be identified by a series of checks that include enhancements to the Xprobe algorithm to correctly identify Solaris 10 machines as Solaris. A UDP packet is sent 302 to a down port on a target that can possibly be a Solaris target with a payload of 70 bytes. If the host responds with an ICMP destination unreachable reply 304, the host may be Solaris 306. The destination unreachable reply can be specified to refer to a complete ICMP destination unreachable response, including an associated Internet Protocol (IP) header. If the destination unreachable reply has a size of 112 308, the host may be Solaris 310.

An ICMP timestamp request is sent 312 to the target host. If the host responds to the ICMP timestamp request 314, the host is Solaris 316. If the host does not respond 318 to the ICMP timestamp request, the host may be Solaris 320.

A UPD packet is sent 322 to a down port on the target with no payload and the IP timestamp option set in the IP header. In a particular embodiment, the IP header options can specify a type of 0×44 indicating timestamp, a timestamp length of 0×28, a timestamp pointer of 0×05, and 0×0 for other timestamp fields. If the host responds with an ICMP destination unreachable reply 324, the host is Solaris 326. In the specific example, the timestamp length of 0×28 corresponds to a value that increases or maximizes the allowable distance from the source host to the destination host or router. The timestamp pointer of 0×05represents an initial pointer at first use which enables as much buffer space as possible for the operation.

Referring to FIG. 4, an output printout depicts results of a test run an embodiment of a method for operating system discovery and identification that enables Solaris 10 to be distinguished from HP-UX 11.x using IP options specifying a record route option. Conventional versions of Xprobe and Nmap have mixed success in distinguishing the operating systems. For example, Xprobe can distinguish Solaris 10 from HP-UX newer than 11.0.

An illustrative enhancement to Xprobe and Nmap can distinguish the operating systems by adding an ICMP address mask request (type 17). Solaris 10 and HP-UX 11.0 both respond to the request, later HP-UX versions do not. Nmap can distinguish Solaris 10 from HP-UX in combination with Pcap. A simple approach can include sending data to an open port (following detection of the open port) with TCP options set and analyzing the order in which the TCP options are specified by the remote machine.

HP-UX 10.2 can be identified by sending a UDP message to a down port with Internet Protocol (IP) Type of Service (ToS) set to 0×f8. The IP header in the response will specify that ToS for HP-UX 10.2. Another operating system, Advanced Interactive eXecutive (AIX) also responds in a similar manner but can be distinguished by evaluating the length field of the embedded IP header which differs by 20 or by other approaches. Accordingly, Solaris 10 can be distinguished from HP-UX older than 11.0 and newer than 11.0, but not 11.0.

IP and ICMP have various options that can be used to find differences across OS types. Various types of messages can be used to distinguish operating systems including an ICMP echo request, an ICMP address-mask-request, ICMP information request, ICMP timestamp request, UDP message to down port (ICMP type 3, code 3 response), UDP message with invalid protocol (ICMP type 3, code 2 response). Some messages, for example ICMP information request and ICMP timestamp request are not supported by either Xprobe or Nmap. For each message type, one or more variations of data elements can be set. Various data elements may include Internet Protocol (IP) Type of Service (ToS), IP identification, IP flags, IP version, IP header length, and IP options including [If ICMP] ICMP code, [If ICMP] ICMP id, [If ICMP] ICMP seq, Payload (0=>1500 bytes), and others.

After making a request, for example an ICMP request with IP ToS, the response is monitored for differences between Solaris 10 and HP-UX 11.0. The response can be monitored to determine whether the ToS is echoed back, whether the header length values in the response are correct, whether the same amount of payload is echoed back, whether the ICMP parameter problem response (as occurs bad IP options) is identical, and the like.

In other applications, a minor difference in handling of a source routing option exists between the Solaris operating system and others can be exploited for OS differentiation. Other IP options that may be useful for OS differentiation can include record route and timestamp, as defined in RFC 791. Record route and timestamp options can be used, for example, with ICMP echo, ICMP address-mask, and down UDP port.

In an illustrative configuration, for record route and timestamp options specified to HP-UX boxes (11.x) with a UDP packet to a down port, a HP-UX system drops the packet, while Solaris (2.6, 2.8, 2.9, 2.10, but not 2.7) responds with a destination unreachable reply while also updating the IP options section with the route/timestamp. The timestamp option enables a more robust OS differentiation than record route of distinguishing HP-UX.

The illustrative output printout 400 shows a packet 402 sent to a down UDP port with IP options specifying the record route option. Solaris 10 (15.2.125.24) responds 404S while HP-UX 11.0 (15.2.120.50) does not 404H. HP-UX behavior with record route depends on space in the header. For example, if the record route section of the IP header only has room for one or zero IP addresses, HP-UX responds. If the record route section has room for two or more addresses, as in the illustrative request, HP-UX does not respond. If the fourth option 406 is changed from \x04 to \x08, which only leaves room for one IP address, the HP-UX system does respond.

The various functions, processes, methods, and operations performed or executed by the system can be implemented as programs that are executable on various types of processors, controllers, central processing units, microprocessors, digital signal processors, state machines, programmable logic arrays, and the like. The programs can be stored on any computer-readable medium for use by or in connection with any computer-related system or method. A computer-readable medium is an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, components, and functions are given by way of example only. The parameters, components, and functions can be varied to achieve the desired structure as well as modifications, which are within the scope of the claims. Variations and modifications of the embodiments disclosed herein may also be made while remaining within the scope of the following claims. For example, a few specific examples of operating systems, message types, and options are described. The illustrative system for operating system identification can be used in conjunction with any suitable operating systems and message protocols. The illustrative techniques may be used with any suitable data processing configuration and with any suitable servers, computers, and devices.

What is claimed is:

1. A method for remotely identifying an operating system comprising:
sending a first User Datagram Protocol (UDP) packet to a port that is not in use on a target;
monitoring a response evoked by the first sent UDP packet;
sending at least one Internet Control Message Protocol (ICMP) packet to the target;
monitoring response evoked by the sent ICMP packet(s);
sending a second UDP packet to the port with an Internet Protocol (IP) timestamp option set in an IP header;
monitoring a response evoked by the second sent UDP packet; and
identifying the operating system at least partially based on the responses to the first and second sent UDP packets.

2. The method according to claim 1 further comprising:
identifying the operating system based on the responses to the first and second sent UDP packets and the response(s) to the sent ICMP packet(s).

3. The method according to claim 1 further comprising:
sending at least one Internet Control Message Protocol (ICMP) packet to the target subsequent to monitoring the response evoked by the first sent UDP packet;
monitoring response evoked by the sent ICMP packet(s); and
identifying the operating system based on the responses to the first and second sent UDP packets and the response(s) to the sent ICMP packet(s).

4. The method according to claim 1 further comprising:
sending the first User Datagram Protocol (UDP) packet with a payload of a preselected number of bytes;
identifying the operating system as possibly Solaris if the response evoked by the first sent UDP packet is an Internet Control Message Protocol (ICMP) destination unreachable reply; and
identifying the operating system as possibly Solaris if the destination unreachable reply has a preselected size.

5. The method according to claim 1 further comprising:
sending an Internet Control Message Protocol (ICMP) timestamp request to the target;
identifying the operating system as Solaris if the target responds to the ICMP timestamp request; and
identifying the operating system as possibly Solaris if the target does not respond to the ICMP timestamp request.

6. The method according to claim 1 further comprising:
sending the second UDP packet to the port with the Internet Protocol (IP) timestamp option set in an IP header specifying a timestamp type, a predetermined timestamp length, a predetermined timestamp pointer, and null for other timestamp fields; and
identifying the operating system as Solaris if the target responds to the second UDP packet with an ICMP destination unreachable reply.

7. The method according to claim 1 further comprising:
sending the second UDP packet to the port with the Internet Protocol (IP) timestamp option set in an IP header specifying a timestamp type of 0×44, a predetermined timestamp length of 0×28, a predetermined timestamp pointer of 0×05, and null for other timestamp fields; and
identifying the operating system as Solaris if the target responds to the second UDP packet with an ICMP destination unreachable reply.

8. A network system comprising:
a controller that remotely identifies an operating system by sending a first User Datagram Protocol (UDP) packet to a port that is not in use on a target and monitoring a response evoked by the first sent UDP packet, the controller further sends at least one Internet Control Message Protocol (ICMP) packet to the target and monitors a response evoked by the sent ICMP packet(s), and sends a second UDP packet to the port with an Internet Protocol (IP) timestamp option set in an IP header and monitors a response evoked by the second sent UDP packet, the controller identifies the operating system at least partially based on the responses to the first and second sent UDP packets.

9. The system according to claim 8 further comprising:
the controller that identifies the operating system based on the responses to the first and second sent UDP packets and the response(s) to the sent ICMP packet(s).

10. The system according to claim 8 further comprising:
the controller that further sends at least one Internet Control Message Protocol (ICMP) packet to the target subsequent to monitoring the response evoked by the first sent UDP packet and monitors a response evoked by the sent ICMP packet(s), the controller identifies the operating system based on the responses to the first and second sent UDP packets and the response(s) to the sent ICMP packet(s).

11. The system according to claim 8 further comprising:
the controller that further sends the first User Datagram Protocol (UDP) packet with a payload of a preselected number of bytes, identifies the operating system as possibly Solaris if the response evoked by the first sent UDP packet is an Internet Control Message Protocol (ICMP) destination unreachable reply, and identifies the operating system as possibly Solaris if the destination unreachable reply has a preselected size.

12. The system according to claim 8 further comprising:
the controller that further sends an Internet Control Message Protocol (ICMP) timestamp request to the target, identifies the operating system as Solaris if the target responds to the ICMP timestamp request, and identifies the operating system as possibly Solaris if the target does not respond to the ICMP timestamp request.

13. The system according to claim 8 further comprising:
the controller that further sends the second UDP packet to the port with the Internet Protocol (IP) timestamp option set in an IP header specifying a timestamp type, a predetermined timestamp length, a predetermined timestamp pointer, and null for other timestamp fields; and identifies the operating system as Solaris if the target responds to the second UDP packet with an ICMP destination unreachable reply.

14. The system according to claim 8 further comprising:
sending the second UDP packet to the port with the Internet Protocol (IP) timestamp option set in an IP header specifying a timestamp type of 0×44, a predetermined timestamp length of 0×28, a predetermined timestamp pointer of 0×05, and null for other timestamp fields; and identifies the operating system as Solaris if the target responds to the second UDP packet with an ICMP destination unreachable reply.

15. A system that facilitates remote identification of an operating system comprising:
means for sending information packets on a network;
means for monitoring responses evoked from the sending of information packets on the network; and
means for controlling identification of the operating system comprising:
means for controlling the sending means and the monitoring means to send a first User Datagram Protocol (UDP) packet to a port that is not in use on a target and monitor a response evoked by the first sent UDP packet;
means for controlling the sending means and the monitoring means to send at least one Internet Control Message Protocol (ICMP) packet to the target and monitor response evoked by the sent ICMP packet(s);
means for controlling the sending means and the monitoring means to send a second UDP packet to the port with an Internet Protocol (IP) timestamp option set in an IP header and monitor a response evoked by the second sent UDP packet; and
means for identifying the operating system at least partially based on the responses to the first and second sent UDP packets.

16. The system according to claim 15 further comprising:
the means for controlling identification of the operating system further comprising:
means for controlling the sending means and the monitoring means to send at least one Internet Control Message Protocol (ICMP) packet to the target subsequent to monitoring the response evoked by the first sent UDP packet and monitor a response evoked by the sent ICMP packet(s); and
means for identifying the operating system based on the responses to the first and second sent UDP packets and the response(s) to the sent ICMP packet(s).

17. The system according to claim 15 further comprising:
the means for controlling identification of the operating system further comprising:
means for controlling the sending means to send the first User Datagram Protocol (UDP) packet with a payload of a preselected number of bytes;
means for identifying the operating system as possibly Solaris if the response evoked by the first sent UDP packet is an Internet Control Message Protocol (ICMP) destination unreachable reply; and
means for identifying the operating system as possibly Solaris if the destination unreachable reply has a preselected size.

18. An article of manufacture comprising:
a controller usable medium having a computable readable program code embodied therein for remotely identifying an operating system, the computable readable program code further comprising:
a code adapted to cause the controller to send a first User Datagram Protocol (UDP) packet to a port that is not in use on a target;
a code adapted to cause the controller to monitor a response evoked by the first sent UDP packet;
a code adapted to cause the controller to send at least one Internet Control Message Protocol (ICMP) packet to the target;
a code adapted to cause the controller to monitor response evoked by the sent ICMP packet(s);
a code adapted to cause the controller to send a second UDP packet to the port with an Internet Protocol (IP) timestamp option set in an IP header;
a code adapted to cause the controller to monitor a response evoked by the second sent UDP packet; and
a code adapted to cause the controller to identify the operating system at least partially based on the responses to the first and second sent UDP packets.

19. The article of manufacture according to claim 18 further comprising:
the computable readable program code further comprising:
a code adapted to cause the controller to send at least one Internet Control Message Protocol (ICMP) packet to the target subsequent to monitoring the response evoked by the first sent UDP packet;
a code adapted to cause the controller to monitor response evoked by the sent ICMP packet(s); and
a code adapted to cause the controller to identify the operating system based on the responses to the first and second sent UDP packets and the response(s) to the sent ICMP packet(s).

20. The article of manufacture according to claim 18 further comprising:
the computable readable program code further comprising:
a code adapted to cause the controller to send the first User Datagram Protocol (UDP) packet with a payload of a preselected number of bytes;
a code adapted to cause the controller to identify the operating system as possibly Solaris if the response evoked by the first sent UDP packet is an Internet Control Message Protocol (ICMP) destination unreachable reply; and
a code adapted to cause the controller to identify the operating system as possibly Solaris if the destination unreachable reply has a preselected size.
